(19) United States
(12) Patent Application Publication
(10) Pub. No.: US 2017/0368394 A1
(43) Pub. Date: Dec. 28, 2017

(54) UTILITY AND APPLIANCE FIRE SUPPRESSION SYSTEM, COMPOSITIONS, AND METHODS

(71) Applicant: Jacob Alan Graham CRITCHLEY, Columbus, OH (US)

(72) Inventor: Jacob Alan Graham CRITCHLEY, Columbus, OH (US)

(21) Appl. No.: 15/632,083

(22) Filed: Jun. 23, 2017

Related U.S. Application Data
(60) Provisional application No. 62/354,008, filed on Jun. 23, 2016.

(51) Int. Cl. A62C 35/10; A62C 3/16; A62C 3/00

(52) U.S. Cl. CPC A62C 35/10; A62C 3/006; A62C 3/16

(57) ABSTRACT

The invention generally encompasses fire suppressant compositions and methods. In certain embodiments, the composition is configured to the heating device, for example, a stove or microwave. In certain embodiments, the invention includes holes to allow heat to enter into a compartment/shell and impinge upon a pressurized pouch containing a suppressant agent. In other embodiments, when a fire occurs it causes an exterior layer or relief valve to rupture the suppressant agent discharging towards the heat source and extinguishing the fire. In another application this complication is connected to an electrical or gas system and cuts the supply when the exterior layer of the device ruptures and releases a suppressant.

This application claims the benefit of U.S. Provisional Patent Application No. 62/354,008, which was filed on Jun. 23, 2016, which is incorporated herein by reference in its entirety.

### I. FIELD OF THE INVENTION

The invention generally encompasses fire suppressant compositions and methods. In certain embodiments, the composition is configured to a heating device, for example, a stove or microwave. In certain embodiments, the invention includes one or more apertures or holes to allow heat to enter into a compartment/shell and impinge upon a pressurized pouch containing a suppressant agent. In other embodiments, when a fire occurs it causes an exterior layer or relief valve to rupture the suppressant agent discharging towards the heat source and extinguishing the fire. In another embodiment, this system is connected to an electrical or gas system and cuts the supply when the exterior layer of the device ruptures and releases a suppressant.

### II. BACKGROUND OF THE INVENTION

Between 2009 and 2013 U.S. fire departments responded to an estimated average of 162,400 structure fires involving cooking equipment per year. During the period 2010 to 2014 an average of 45,210 electrical distribution systems for structures involving electrical outlets, light switches, and lighting appliances were recorded. As a result of these fires hundreds of civilians died or were injured and billions of dollars in direct property damage resulted.

The first sprinkler systems that can be compared to todays originated in the 1850's and consisted of perforated pipes connected throughout a building structure and to a supply of water. Today sprinkler systems are required throughout manufacturing plants, schools, and other facilities based on the different intentions of what the structure was designed to be used. As time passes more people are recognizing the need for fire protections systems to be introduced into the residential housing communities throughout the country. The problem with the suppression systems of today is that they require a supply source of water and a mechanical system that can identify as well as transport the necessary water to location of the fire. Such systems can be installed in residential homes that are being constructed or previously built but are not required. In most instances, people feel that a fire will not happen to them so they do not need to spend the money to have a system installed.

The instant system and composition uses the fire dynamics of the heat from a fire to identify and direct the suppressant to the assigned heat affected appliance. The pressurized container can be installed above the center of the stove, within a household appliance, or surrounding a structure's electrical system. When an area of this device is exposed to the heat from the item on fire the suppressant agent will be released in the direction of the source of the heat from the fire. Due to the design of the product the suppressant can be released at any direction that has a direct line of site to the object producing the heat. This device does not require a power source or a notification application/system from the suppression device or another device. In certain embodiments, the suppressant is projected towards the fire through the force contained within the pressurized container holding the suppressant with the aid of propellant, for example, compressed air or CO₂ and does not require an accelerant or explosive.

### III. SUMMARY OF THE INVENTION

In one embodiment, the invention encompasses a composition including a compartment (for example, a partially metal, or spherical/curved metal compartment) containing a pressurized pouch including a fire suppressant. In certain embodiments, the pouch includes, for example, one or more apertures or holes. In certain embodiments, the device is attached to a heating system, for example, the middle of the underside of a microwave or hood system above a stove. In certain embodiments, the holes allow heat to enter into the compartment/shell and impinge upon a pressurized pouch containing a suppressant agent. In certain embodiments, when a fire occurs and grows large enough in size to produce the necessary heat to cause the pouches exterior layer or relief valves to rupture, the fire suppressant agent will be discharged. In certain embodiments, the discharge of the fire suppressant is towards the heat source and extinguishes the fire. In certain embodiments, the device is connected to an electrical or gas system and cuts the supply to the stove when the exterior layer of the device ruptures and releases its suppressant.

In another application, the pressurized pouch is a desired shape of the interior compartment of an electrical appliance. In certain embodiments, when one of the appliances electrical components experiences an electrical failure and begins to produce an amount of heat that is able to rupture the exterior layer or relieve valves of the pressurized pouch the suppressant within the pouch well be expelled in the direction of the heat source. In certain embodiments, once the exterior layer or relieve valves of the device has been ruptured and the suppressant released an electrical conductor connected from the pressurized pouch to the power cord of the appliances will signal the appliance to cut off the flow of electricity to the affected appliance.

In another application of this device, the pressurized pouch containing the suppressant agent is oriented in a direct line of site to a structures electrical systems components including outlets, light switches, and lighting fixtures. In the event that one of the electrical components of the above mentioned structures electrical system experiences an electrical failure and produces enough heat to rupture the exterior layer or relief valves of the pressurized pouch the suppressant will be discharged in the direction of the heat source. In another application of this device, once the exterior layer of the pouch has been ruptured the power being supplied to the electrical appliance producing the heat will be terminated.

### IV. BRIEF DESCRIPTION OF THE DRAWINGS

FIGS. 1a and 1b illustrate exemplary non-limiting embodiments of a pouch including a fire suppressant composition.

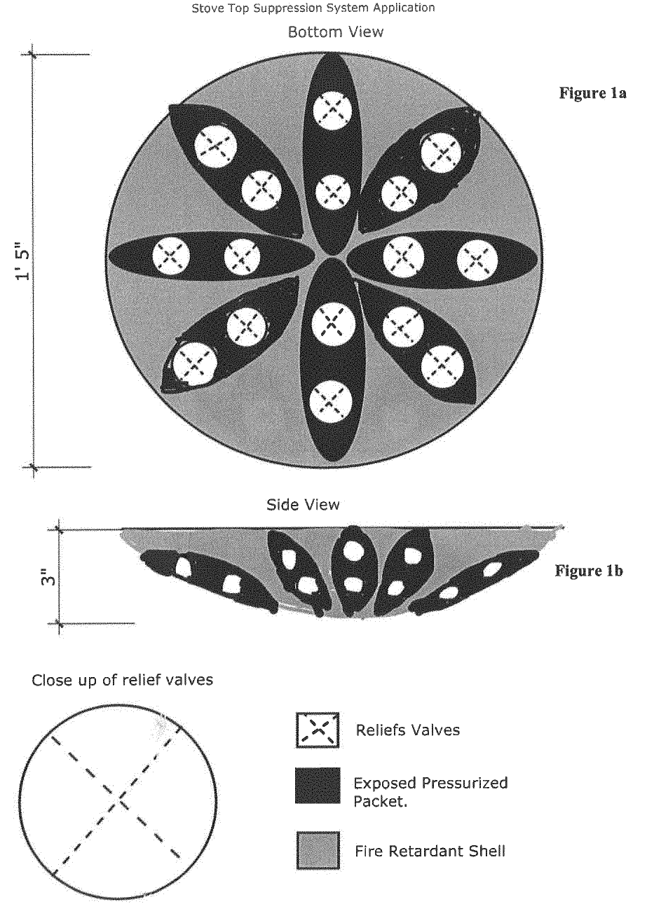

### V. DETAILED DESCRIPTION OF THE INVENTION

The invention encompasses a fire suppressant system that includes a pouch including a fire suppressant. In certain embodiments, the system includes a ⅓-½ spherical metal compartment/shell with perforated holes in the rounded bottom. In certain embodiments, the holes in the bottom of the container/shell will be arranged in a decorative design that will allow a direct line of site from all four burners or heating elements to the pressurized pouch with suppressant in it held within. In certain embodiments, the partially spherical shape is important to the design of the product in order to insure that the heat from the fire is absorbed by the pressurized pouch from the proper direction and angle of which the fire is located. In certain embodiments, the pressurized containers will be in ⅓-½ spherical shape mirroring the shell in order to maximize the amount of suppressant that can fit into the device. This compartment/shell with the pressurized pouch inside will be attached to the underside of the stoves hood system or microwave above the stove.

In another embodiment, the pressurized pouch is positioned in a compartment above an electrical outlet, light switch, or light fixture located within a structure. In certain embodiments, the compartment containing the pressurized pouch will be attached to the compartment containing the above mentioned structural electrical system components allowing the pressurized pouch a direct line of sight to the electrical component. In the event that the structure's electrical component experiences and electrical failure heat will enter the pressurized container until the exterior layer of the device is compromised and the suppressant agent within the pressurized pouch will be expelled onto the outlet. In certain embodiments, the once the exterior layer of the pouch has been compromised the electrical current to the involved electrical components will be terminated.

In another embodiment, the pressurized pouch containing the suppressant agent will be designed into a shape to fit inside an electrical appliance near the potential ignition sources within the designated appliance. In certain embodiments, the pouch will not confine the movements or applications of the designated appliance but will have a direct line of site to the known potential ignition sources within the appliance. In certain embodiments, in the event that one of the electrical components of the designated appliance experiences and electrical failure the heat produced will impinge upon the pressurized pouch until the exterior layer of the pouch ruptures and the suppressant agent is released. In certain embodiments, the when the exterior layer is compromised the electric supply to the involved appliance will be terminated.

### A. Exemplary Materials for the Compartment/Shell

In certain embodiments, the compartment/shell that which will hold all the pressurized pouch of this device can be made of a variety of materials. The main attribute behind this aspect of the device is that it does not warp or melt during the duration of its use with the product. In certain embodiments, as long as the compartment/shell does not melt over time that would prohibit the pressurized pouch from being exposed to the heat from involved heat source in the particular scenario. In certain embodiments, the potential material used for the encasing of the pressurized suppression pouch could be aluminum. In one embodiment, brass could be used. Another potential metal used for this devices outer compartment is bronze. In still another embodiment for this device cast iron could be used as the compartment/shell. Yet another material that could be used for this devices outer shell could be copper. In another embodiment of this device gold could be used as the compartments make up. A potential material used for the encasing of the pressurized suppression device could be iron. In one embodiment, the metal is lead. In still another embodiment for this device nickel could be used. Yet another material that could be used for this devices outer shell could be platinum. In another embodiment of this device brass could be used. A potential material used for the encasing of the pressurized suppression device could be silver. In one embodiment, the metal is stainless steel. Another potential metal used for this devices outer frame is a low, medium, high carbon based steel. In still another embodiment for this device titanium could be used. Yet another material that could be used for this devices outer shell could be yellow brass. In another embodiment of this device zinc could be used. A potential material used for the encasing of the pressurized suppression device could be actinium. In one embodiment, the metal is uranium. Another potential metal used for this devices outer frame is americium. In still another embodiment for this device barium could be used. Yet another material that could be used for this devices outer shell could be berkelium. In another embodiment of this device beryllium could be used. A potential material used for the encasing of the pressurized suppression device could be bismuth. In one embodiment, the metal is bohrium. Another potential metal used for this devices outer frame is cadmium. In still another embodiment for this device calcium could be used. Yet another material that could be used for this devices outer shell could be californium. In another embodiment of this device cerium could be used. A potential material used for the encasing of the pressurized suppression device could be cesium. In one embodiment, the metal is chromium. Another potential metal used for this devices outer frame is cobalt. In still another embodiment for this device curium could be used. Yet another material that could be used for this devices outer shell could be darmstadtium. In another embodiment of this device dubnium could be used. A potential material used for the encasing of the pressurized suppression device could be dysporosium. In one embodiment, the metal is einsteinium. Another potential metal used for this devices outer frame is erbium. In still another embodiment for this device europium could be used. Yet another material that could be used for this devices outer shell could be fermium. In another embodiment of this device francium could be used. A potential material used for the encasing of the pressurized suppression device could be gadolinium. In one embodiment, the metal is gallium. Another potential metal used for this devices outer frame is hafnium. In still another embodiment for this device hassium could be used. Yet another material that could be used for this devices outer shell could be holmium. In another embodiment of this device indium could be used. A potential material used for the encasing of the pressurized suppression device could be iridium. In one embodiment, the metal is lanthanum. Another potential metal used for this devices outer frame is lawrencium. In still another embodiment for this device lithium could be used. Yet another material that could be used for this devices outer shell could be lutetium. In another embodiment of this device magnesium could be used. A potential material used for the encasing of the pressurized suppression device could be manganese. In one embodiment, the metal is meitnerium. Another potential metal used for this devices outer frame is mendelevium. In still another embodiment for this device mercury could be used. Yet another material that could be used for this devices outer shell could be molybdenum. In another embodiment of this device neodymium could be used. A potential material used for the encasing of the pressurized suppression device could be neptunium. In one embodiment, the metal is niobium. Another potential metal used for this devices outer frame is nobelium. In still another embodiment for this device osmium could be used. Yet another material that could be used for this devices outer shell could be palladium. In another embodiment of this device platinum could be used. A potential material used for the encasing of the pressurized suppression device could be plutonium. In one embodiment, the metal is polonium. Another potential metal used for this devices outer frame is potassium. In still another embodiment for this device praseodymium could be used. Yet another material that could be used for this devices outer shell could be promethium. In another embodiment of this device protactinium could be used. A potential material used for the encasing of the pressurized suppression device could be radium. In one embodiment, the metal is rhenium. Another potential metal used for this devices outer frame is rhodium. In still another embodiment for this device roentgenium could be used. A potential material used for the encasing of the pressurized suppression device could be Rubidium. In one embodiment, the metal is ruthenium. Another potential metal used for this devices outer frame is rutherfordium. In yet another version of this device red brass could be used as the shell of the device. In still another embodiment for this device samarium could be used. Yet another material that could be used for this devices outer shell could be scandium. In another embodiment of this device seaborgium could be used. A potential material used for the encasing of the pressurized suppression device could be strontium. In one embodiment, the metal is tantalum. Another potential metal used for this devices outer frame is technetium. In still another embodiment for this device terbium could be used. Yet another material that could be used for this devices outer shell could be thallium. In another embodiment of this device thorium could be used. A potential material used for the encasing of the pressurized suppression device could be thulium. In one embodiment, the metal is tin. Another potential metal used for this devices outer frame is tungsten. In still another embodiment for this device ununbium could be used. Yet another material that could be used for this devices outer shell could be uranium. In another embodiment of this device ununhexium could be used. A potential material used for the encasing of the pressurized suppression device could be ununpentium. In one embodiment, the metal is ununquadium. Another potential metal used for this devices outer frame is ununtrium. In still another embodiment for this device vanadium could be used. Yet another material that could be used for this devices outer shell could be ytterbium. In another embodiment of this device yttrium could be used. A potential material used for the encasing of the pressurized suppression device could be zirconium. Another potential material used for this aspect of the device is a thermoplastic elastomer compound. In another application of this aspect of the device fiber reinforced plastic could be used for the shell. In summary any metal or metal based material can be used in this aspect of the device.

### B. Suppressant Agents for the Device

A potential material used for the suppressant agent of the pressurized suppression device could be Water. In one embodiment, the suppressant material is ABC suppressant agent. Another potential material used for this devices suppressant component could be AB. In still another embodiment for this device BC agent could be used to suppress the fire. Yet another material that could be used for this devices suppressant agent could be dry chem. In another embodiment of this device aqueous foam (AFFF) could be used to eliminate the fire. A potential material used for the suppressant agent of the pressurized suppression device could be. In one embodiment, the suppressant material is aqueous foam in a low, medium or high expansion rate. Another potential material used for this devices suppressant component could be Alcohol Resistant foam (AR-AFFF). In still another embodiment for this device Class A foam concentrates could be used to suppress the fire. Yet another material that could be used for this devices suppressant agent could be class B foams. In another embodiment of this device synthetic, medium or high expansion type detergents could be used to eliminate the fire. A potential material used for the suppressant agent of the pressurized suppression device could be. In one embodiment, the suppressant material is wetting agent. Another potential material used for this devices suppression component could be protein foam. In still another embodiment for this device clean agent could be used to suppress the fire. Yet another material that could be used for this devices suppressant agent could be film-forming fluoroprotien. In another embodiment of this device baking soda could be used to eliminate the fire. A potential material used for the suppressant agent of the pressurized suppression device could be purple-K. In one embodiment, the suppressant material is super K (potassium chloride). Another potential material used for this devices suppressant component could be firefighter foam. In still another embodiment for this device Halon gases could be used to suppress the fire. Yet another material that could be used for this devices suppressant agent could be alcohol resistant foam. In another embodiment of this device ammonium polyphosphate dry chemical could be used to eliminate the fire. A potential material used for the suppressant agent of the pressurized suppression device could be ammonium polyphosphate dry chemical. In one embodiment, the suppressant material is monoammonium phosphate. Another potential material used for this devices suppressant component could be sodium bicarbonate. In still another embodiment for this device potassium bicarbonate & Urea complex could be used to suppress the fire. Yet another material that could be used for this devices suppressant agent could be potassium chloride. In another embodiment of this device foam-compatible, which is a sodium bicarbonate could be used to eliminate the fire. A potential material used for the suppressant agent of the pressurized suppression device could be MET-L-KYL/PYROKYL. In one embodiment, the suppressant material is CAFS (compressed air foam system). Another potential material used for this devices suppressant component could be Arctic Fire. In still another embodiment for this device wetting agent could be used to suppress the fire. Yet another material that could be used for this devices suppressant agent could be antifreeze. In another embodiment of this device CO2 could be used to eliminate the fire. A potential material used for the suppressant agent of the pressurized suppression device could be potassium based dry chemical. In one embodiment, the suppressant material is a sodium based suppressant agent. Another potential material used for this devices suppressant component could be KNHO3. In still another embodiment for this device clean agent could be used to suppress the fire. Yet another material that could be used for this devices suppressant agent could be sand. In another embodiment of this device water dry chemical Halon Carbon dioxide Foam could be used to eliminate the fire.

### C. Exemplary Materials Used for the Pressurized Pouch Containing the Suppressant Agent

In certain embodiments, the activation of the compressed pouch results from the failure of a fusible link held together by a temperature sensitive alloy. A potential concept is for the container is for it to be made out of the alloy used to hold the fusible link together. A potential material used to contain the suppression agent used in this device could be linins. Another potential material that could be used to encapsulate the suppression agent could be tin. In one embodiment of this device laminated aluminum foil could be used to hold the suppression agent used. Another potential material used to contain the suppression agent is zinc. In another embodiment of this device glass could be used to house the suppression agent within this device. In one version of the device polyester would contain the pressurized suppressant. Another potential material used for the pouch could be polyethylene.

A potential material used for the encasing of the suppression agent could be aluminum. In one embodiment, the metal covering is brass. Another potential container used for this devices pressurized container is bronze. In still another embodiment for this device cast iron could be used. Yet another material that could be used for this devices pressurized container could be copper. In another embodiment of this device gold could be used. A potential material used for the encasing of the suppression agent could be iron. In one embodiment, the pressurized container is lead. Another potential metal used for these devices pressurized containers is lithium. In still another embodiment for this device nickel could be used. Yet another material that could be used for these devices pressurized capsules could be platinum. In another embodiment of this device brass could be used. A potential material used for the encasing of the suppression agent could be silver. In one embodiment, the pressurized capsule is stainless steel. Another potential metal used for this devices pressurized capsule is a low, medium, high carbon based steel. In still another embodiment for this device titanium could be used. Yet another material that could be used for this devices pressurized container could be yellow brass. In another embodiment of this device zinc could be used. A potential material used for the encasing of the pressurized suppression agent could be actinium. In one embodiment, the metal is uranium. Another potential metal used for this devices pressurized capsule is americium. In still another embodiment for this device barium could be used. Yet another material that could be used for this devices pressurized capsule could be berkelium. In another embodiment of this device beryllium could be used. A potential material used for the encasing of the pressurized suppression agent could be bismuth. In one embodiment, the metal capsule is bohrium. Another potential metal used for this devices pressurized capsule is cadmium. In still another embodiment for this device calcium could be used. Yet another material that could be used for this devices pressurized container could be californium. In another embodiment of this device cerium could be used. A potential material used for the encasing of the pressurized suppression agent could be cesium. In one embodiment, the metal container is made of chromium. Another potential metal used for this devices pressurized container is cobalt. In still another embodiment for this device curium could be used. Yet another material that could be used for this devices pressurized capsule could be darmstadtium. In another embodiment of this device dubnium could be used to contain the suppressing agent. A potential material used for the encasing of the pressurized suppression agent could be dysprosium. In one embodiment, the metal container is einsteinium. Another potential metal used for this devices pressurized capsule is erbium. In still another embodiment for this device europium could be used to contain the suppressant agent. Yet another material that could be used for this devices pressurized container could be fermium. In another embodiment of this device francium could be used with hold the suppressant agent. A potential material used for the encasing of the pressurized suppression agent could be gadolinium. In one embodiment, the metal for the capsule is gallium. Another potential metal used for this devices pressurized container is hafnium. In still another embodiment for this device hassium could be used to hold the suppression agent. Yet another material that could be used for this devices pressurized capsule could be holmium. In another embodiment of this device indium could be used to hold the suppression agent. A potential material used for the encasing of the pressurized suppression agent could be iridium. In one embodiment, the metal to hold the suppression agent is lanthanum. Another potential metal used for this devices pressurized container is lawrencium. In still another embodiment for this device lithium could be used to hold the suppression agent. Yet another material that could be used for this devices pressurized capsule could be lutetium. In another embodiment of this device magnesium could be used to hold the suppression agent. A potential material used for the encasing of the pressurized suppression agent could be manganese. In one embodiment, the metal is meitnerium to hold the suppression agent. Another potential metal used for this devices pressurized capsule is mendelevium. In still another embodiment for this device mercury could be used to hold the suppression agent. Yet another material that could be used for this devices pressurized container could be molybdenum. In another embodiment of this device neodymium could be used to hold the suppression agent. A potential material used for the encasing of the pressurized suppression agent could be neptunium. In one embodiment, the metal is niobium to hold the suppression agent. Another potential metal used for this devices pressurized capsule is nobelium. In still another embodiment for this device osmium could be used to contain the suppression agent. Yet another material that could be used for this devices suppression agent could be palladium. In another embodiment of this device platinum could be used to hold the suppression agent. A potential material used for the encasing of the pressurized suppression agent could be plutonium. In one embodiment, the metal is polonium to contain the suppression agent. Another potential metal used for this devices pressurized capsule is potassium. In still another embodiment for this device praseodymium could be used to contain the suppression agent. Yet another material that could be used for this devices outer shell could be promethium. In another embodiment of this device protactinium could be used to hold the pressurized suppression agent. A potential material used for the encasing of the pressurized suppression agent could be radium. In one embodiment, the metal is rhenium could encapsulate the suppression agent. Another potential metal used for this devices pressurized capsule is rhodium. In still another embodiment for this device roentgenium could be used to hold the suppression agent. Yet another material that could be used for this devices pressurized capsule could be rhodium. In another embodiment of this device roentgenium could be used. A potential material used for the encasing of the pressurized suppression agent could be rubidium. In one embodiment, the metal is ruthenium to encapsulate the pressurized suppression agent. Another potential metal used for this devices pressurized capsule is rutherfordium. In yet another version of this device red brass could be used as the pressurized container. In still another embodiment for this device samarium could be used to hold the suppression agent. Yet another material that could be used for this devices pressurized capsule could be scandium. In another embodiment of this device seaborgium could be used to hold the suppression agent. A potential material used for the encasing of the pressurized suppression agent could be strontium. In one embodiment, the metal is tantalum to contain the suppression agent. Another potential metal used for this devices pressurized capsule is technetium. In still another embodiment for this device terbium could be used to hold the suppression agent. Yet another material that could be used for this devices pressurized container could be thallium. In another embodiment of this device thorium could be used to hold the suppression agent. A potential material used for the encasing of the pressurized suppression agent could be thulium. In one embodiment, the metal is tin to hold the pressurized suppression agent. Another potential metal used for this devices pressurized capsule is tungsten. In still another embodiment for this device ununbium could be used to hold the suppression agent. Yet another material that could be used for this devices pressurized container could be uranium. In another embodiment of this device ununhexium could be used to hold the suppression agent. A potential material used for the encasing of the pressurized suppression agent could be ununpentium. In one embodiment, the metal is ununquadium to hold the suppression agent. Another potential metal used for this devices pressurized capsule is ununtrium. In still another embodiment for this device vanadium could be used to hold the suppression agent. Yet another material that could be used for this devices pressurized capsule could be ytterbium. In another embodiment of this device yttrium could be used to hold the suppression agent. A potential material used for the encasing of the pressurized agent device could be zirconium. In summary any metal or metal based material can be used in this aspect of the device.

### D. Exemplary Pressures Levels

In certain embodiments, the structures are not created equally and therefore the setup, electrical system, or appliance within a structure will be different from another. Because of this the distance from the potential ignition source to the pressurized pouch will differ from situation to situation. In certain embodiments, in order for this device to be affective the suppressant is able to not only reach the heat source from which a fire is located, but it also does not push whatever material is on fire out of whatever container it's holding the affected item and spread the fire throughout the structure. Because of this the pressure at which the container holding the suppressant must be adjusted. Accordingly, in certain embodiments, the suppressant device's pressurized container is able to withstand pressures from 1 psi to 100 psi.

### E. Additional Attachment Embodiments for this Device

Although the main function of this device is to detect and extinguish a fire there are several attachments, which can be added to the device to ensure extended safety features. One of these attachments includes a communication wire connecting from the suppression device is that it is connected to a separate siren located in the structure designated to this device. Although the smoke detector will fulfill its duties and notify the tenants of the smoke many times the tenant will disable the smoke detector or smoke has not yet reached the smoke detector. This siren/notification system will only be associated with this device. When the device activates and expels the suppressant onto the heat source the nearby indicator will activate as well in order to notify tenants who were not in or near the near area when the fire occurred. The siren/notification system will not only notify the tenants of the potential fire but also remind them to leave the premises and call 911 in order to have the proper authorities come and investigate the true nature of the fire. For people who have unfortunately lost their ability to hear the siren light bulbs associated with the device will flash when the siren is activating due to the activation of the suppression device. Another attachment that can be accompanied with the device will be connected to the incoming power supply associated with the affected item/appliance. When the pressurized container releases the suppressant onto the fire the device will notify the attachment the presence of a heat and cut off the electrical or gas supply to the affected item/appliance that is producing the unnecessary heat source. This will prohibit a rekindle of the fuel source from being ignited again. Another embodiment of this device is the implementation of nozzles or “sprinkler heads” could be used to direct the released suppression agent in a particular direction to the heat source.

### F. Installation of the Device

In one aspect of this device the device will be attached by a mounting system to the underside of the microwave or hood system. Another potential manor of installing this device could be through the application of magnets. In another aspect of this device the pressurized pouch containing the suppressant agent is attached to the interior of an appliance with direct line of site to potential ignition sources within the device. In another application of this device the pressurized pouch is positioned in a compartment above an electrical outlet, light switch, or light fixture located within a structure. The compartment containing the pressurized pouch will be attached to the compartment containing the above mentioned structural electrical system components allowing the pressurized pouch a direct line of sight to the electrical component.

While the disclosure has been particularly shown and described with reference to preferred embodiments and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

What is claimed:

1. A fire suppressant composition comprising:
a. a pouch or bladder including one or more apertures;
b. a rupture opening on the pouch or bladder; and
c. a fire suppressant included within the pouch or bladder.

2. The fire suppressant composition of claim 1, wherein the pouch or bladder is pressurized.

3. The fire suppressant composition of claim 1, wherein the pouch or bladder is a metal compartment.

4. The fire suppressant composition of claim 1, wherein the metal compartment is contoured to the shape of an electrical or heating appliance.

5. The fire suppressant composition of claim 1, wherein the metal compartment is spherical or curved.

6. The fire suppressant composition of claim 1, wherein the fire suppressant composition is included with a heating system.

7. The fire suppressant composition of claim 1, wherein the fire suppressant composition is connected to an electrical or gas system.

8. A method for suppressing or eliminating a fire comprising:
a. attaching a pressurized pouch or bladder including one or more apertures to a device, wherein the pouch or bladder includes:
1. a rupture opening on the pouch or bladder; and
2. a fire suppressant included within the pouch or bladder
b. contacting the pouch or bladder with a heat source;
c. heating the apertures to cause the rupture opening in the pouch or bladder to release the fire suppressant included within the pouch or bladder to contact said source of heat.

9. The method of claim 8, wherein the device is a heating or electrical device.

10. The method of claim 8, wherein the heat source is smoke or fire.

11. The method of claim 8, wherein heat from the heat source enters the apertures.

12. The method of claim 11, wherein heat from the heat source that enters the apertures causes the pouch or bladder to open or burst releasing the fire suppressant.

13. The method of claim 8, wherein the pressurized pouch or bladder device is connected to an electrical or gas system.

14. The method of claim 8, wherein the exterior layer of the device ruptures and releases its suppressant.
